(19) United States
(12) Patent Application Publication
(10) Pub. No.: US 2007/0242870 A1
(43) Pub. Date: Oct. 18, 2007

(54) System And Method For Automatically Counting Bundled Items

(75) Inventors: Craig Anderson, Plymouth, UT (US); Doug Adams, Plymouth, UT (US); Scott Laurenti, Plymouth, UT (US)

Correspondence Address: HAHN LOESER & PARKS, LLP, One GOJO Plaza, Suite 300, AKRON, OH, 44311-1076, US

(73) Assignee: Nucor Corporation, Charlotte, NC (US)

(21) Appl. No.: 11/379,147

(22) Filed: Apr. 18, 2006

(51) Int. Cl. G06K 9/00

(52) U.S. Cl. 382/141

(57) ABSTRACT

A system and method for automatically counting a bundled group of metal rods, bars, angles or other items having discernible configuration portions includes a imaging device, such as digital camera, a computer and a computer algorithm that processes images form the imaging device and counts the number of discernible configurations in the image. The item count is generated by the computer algorithm whereby an inventory system, for tracking the stocked units of the discernible configuration is updated responsive to the output from the computer algorithm.

### TECHNICAL FIELD

The present invention pertains to an automated counting system, and more specifically, to a system and method for counting and tagging a bundle of items, such as steel or other metal objects.

### BACKGROUND OF THE INVENTION

Typically, buyers of steel and other metal products, such as rods, bars, angles, beams and the like, are purchased by weight and not by number, A buyer may purchase, for example, one (1) ton of cylindrical steel rod. The grade of the material may vary. The end user may require mild steel, stainless steel or another material. As the density varies with the type of material, the weight per unit, e.g. rod, also varies. The buyer may have additional constraints when purchasing these types of materials including cross-sectional configuration, length, and the like. Accordingly, the manufacturer may produce different types of products segmented into these categories to meet customer needs. As such, an order for one (1) ton of a particular product will produce different numbers of the items based upon the type of material and configuration.

In the past, once an order for material had been received and processed, typically the material was gathered and stacked in bundles according to weight. The items may be stacked on a scale for weighing the items. Items may be added to the stack until the weight requirement has been met. As a result, the unit count of items in the bundles would vary, sometimes widely, based on the configuration and type of material purchased. As a result, a producer of material of this type may warehouse very inaccurate numbers of different items of material, and inaccurate count of the items in an inventory system may be incorporate an accounting database.

In the past, once the items have been weighed and stacked, the bundles may then be banded for shipment. To accurately account for the number of units sold, the inventory will need to be reconciled with the purchase order. Even physically counting the items, which was generally not economical, may result in inaccurate tracking of the number of items bundled. As it is important to ensure that the customer receives the proper quantity of material purchased, a precise method of counting the units is essential to avoid waste and loss of profits. What is needed is a counting system that can automatically track the item count of the number of units of the material sold, and automatically update the count in inventory of the units. The system would be further enhanced by a system that can discriminate between items of different cross-sectional configuration and provide an automatic count of items of different cross-sectional configuration in the same bundle.

### SUMMARY OF THE INVENTION

The present invention provides method of counting a plurality of items comprising the steps of providing at least a first logic processor and a computer algorithm capable of recognizing a discernible configuration on an image and counting the number of similar discernible configurations on the image, capturing an image of at least discernible configuration portions of a plurality of items having discernible configurations, converting the image into an electronic data file that the computer algorithm is capable of recognizing, and interrogating the electronic data file using the computer algorithm to automatically count the number of discernible configurations on the image.

The discernible configuration portion of the items may be typically the cross sectional configuration. The image of the discernible configuration portions of a plurality of items having discernible configurations may be a digital image. The computer algorithm may be capable of distinguishing between a first discernible configuration and one or more substantially different discernible configurations on an image, and counting the numbers of items with different discernible configurations of the first as well as the other discernible configurations on the image.

The method of counting a plurality of items may comprise the additional step of bundling the plurality of items before capturing the image of at least the discernible cross-sectional configuration portions of a plurality of items having discernible cross-sectional configurations. The method of counting a plurality of items may in addition comprise the additional step of stacking the plurality of items together to form the bundle until an estimated or a predetermined weight has been achieved.

The method of counting a plurality of items may further comprise the step of tracking the inventory of the plurality of items, and updating the inventory responsive to counting the number of the plurality of items.

The method of counting a plurality of items may further comprise the step of tagging the plurality of items with an item count generated from the computer algorithm.

A system for counting a plurality of items grouped together in a bundle may comprise a camera for converting images into an electronic data file, a computer operatively communicated to the camera and being adapted to interrogate the data file through a program to count the number of said items imaged in the data file, and an information database operatively communicated to the computer capable of storing in inventory data the count of said items and updating the information data base responsive the count of said items.

Also disclosed is a system for counting a plurality of items grouped together in a bundle, that comprises an image capturing device, such as a digital camera, for converting images to an electronic data file, at least a first logic processor operatively communicated to receive the data file from the image capturing device, and having using a computer algorithm capable of analyzing the data file to identify to output the number of plurality of items grouped together in a bundle, memory operatively communicated to the logic processor for use in storing data capable of storing the number identified of the plurality of items grouped in a bundle, and a printer operatively communicated to said first logic processor capable of printing on bundle tags the number identified of the plurality of items grouped in a bundle. The first logic processor may be a microcomputer comprising a microprocessor and a memory for storing electronic data.

A second logic processor may be operatively communicated to the first logic processor, and have memory for use in storing inventory data, where the inventory data may be automatically updated responsive the output from the computer algorithm identifying the number of the plurality of items grouped together in a bundle. Also, the system for counting a plurality of items grouped together in a bundle may further comprise a scale capable of weighing the plurality of items grouped in the bundle.

### BRIEF DESCRIPTION OF THE DRAWINGS

FIG. 1 is a side perspective view of the imaging system and bundled units according to the embodiments of the subject invention.

FIG. 2 is an end perspective view of the imaging system and bundled units according to the embodiments of the subject invention.

FIG. 3 is a block diagram of the process for automatically counting and updating the inventory according to the embodiments of the subject invention.

### DETAILED DESCRIPTION OF THE INVENTION

Referring now to the drawings some embodiments of the invention are illustrated in greater detail. The automated counting system 1 may include a logic processing unit 3, a digital imaging device 5, an output item count 8 and a display 11 for displaying digital images. In one embodiment, the automated counting system 1 may be used to count material grouped together in a bundle. The material 13 to be counted may be metallic material in units having a discernible configuration. For example, the material may be steel, steel alloy or other metallic substance or alloy fashioned in shapes having discernible cross-sections, including but not limited to rods, bars, beams, and/or angles. However, the invention could be used for counting units of materials having any discernible configuration gathered together in any manner. The units of material 13 may have a predetermined length and have discernible configurations. The units of material 13 may be continuously stacked onto a scale 16 until the desired weight of the material has been reached. Alternatively, no scale is used and the weight is estimated in anticipation of the use of the counting system herein described.

In this manner, the units of material 13, e.g. rods or bars, may be randomly stacked as they are being bundled or otherwise gathered together. It is noted here that units of materials having different discernible configurations, e.g., cross sections, may be loaded onto the same stack as explained in detail below. Although weighing is not necessary, the material may be weighed by any device as is appropriate for the embodiments of the subject invention. If desired, as or after the actual or estimated weight of the material has been reached, the automated counting system 1 may automatically count the number of items in the bundle 14. The bundle 14 may then be banded together and tagged with the number of units, or items, of the material in the bundle 14 for shipment to the desired location.

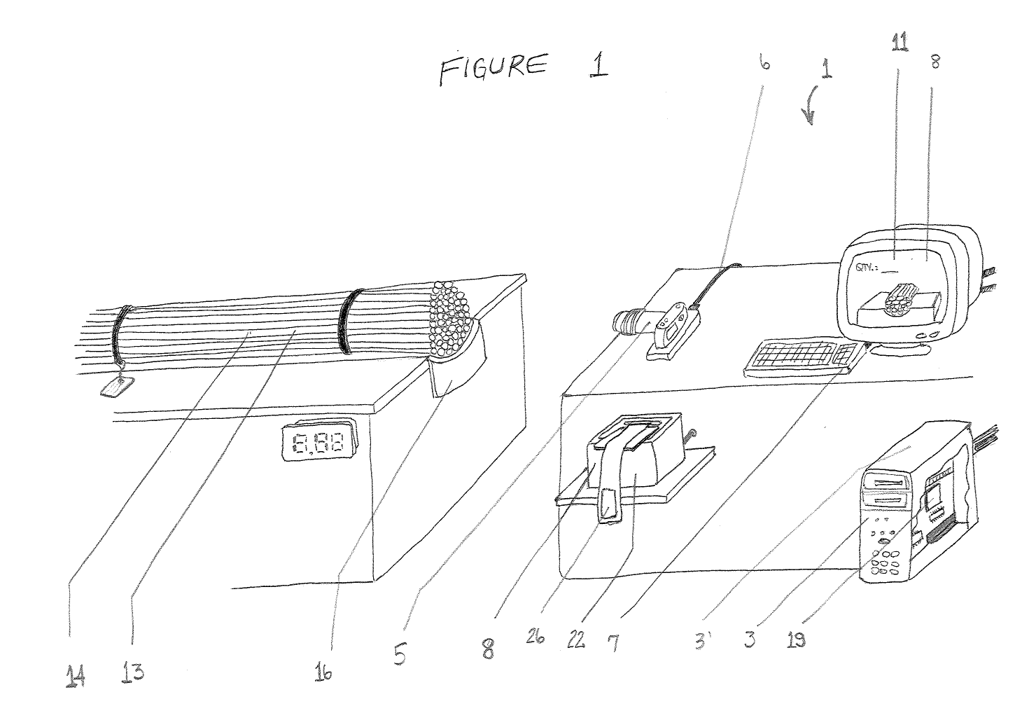

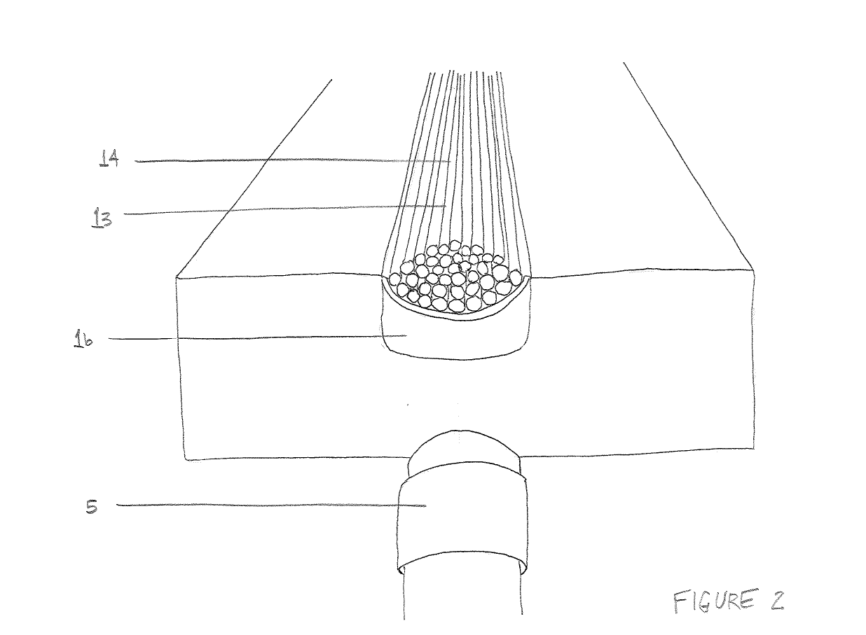

Referring to FIG. 2 along with FIG. 1, automated counting system 1 includes a imaging device 5. The imaging device 5 may be a digital camera, CCD (charge coupled device) camera, image sensor or other device that functions to capture and convert an image to an electronic representation of the image. Any type of camera or device with appropriate resolution may be used to capture an image of the items to be counted, wherein the captured image can subsequently be converted into an electronic data file. A digital image is particularly useful for this purpose. In any case, when activated, the imaging device 5 may capture a picture of the discernible configurations portion, e.g., the end portion, of the bundle 14 for the purpose of counting the number of items in the bundle 14. Accordingly, the imaging device 5 may be positioned adjacent one end of the bundled items, and an image capture of the end view of the bundle 14.

In one embodiment, the imaging device 5 may be positioned adjacent a center of the end of the bundle 14. However, the imaging device 5 may be positioned at any convenient location around the periphery of the bundle, and at any distance from the bundle 14 as is appropriate for capturing an image of sufficient resolution for effectively determining the discernible configurations of the items of material in the bundle 14. Once the imaging device 5 has captured the image of the discernible configurations portions of the bundle 14, the imaging device 5 may then at least temporarily store an electronically converted image of the discernible configuration portion of the bundle 14 in a data file on the imaging device 5. In this manner, the imaging device 5 may include a memory to store data in electronic format, and specifically to store electronic images of the discernible configurations of the items in bundled 14 to be counted. The imaging device 5 may then transfer the electronically converted image to a data file in the logic processing unit 3 to be described below.

It is noted that in another embodiment once the imaging device 5 has captured the image of the discernible configurations portion of the bundle 14, the imaging device 5 may transfer the electronically converted image directly to the logic processing device 3 for storing the image in memory. However, any convenient manner of transferring the image to the processing device may be selected. The transfer of the image data to the logic processing device 3 may be automatic. When the imaging device 5 has been activated to capture the image of the discernible configurations portion of bundle 14, the imaging device 5 may be configured to automatically communicate the data file of the image to the logic processing unit 3. The data may be transmitted via electrical conductors or cables 6 in a manner well known in the art. Alternatively, data may be transferred wirelessly using RF waves or the like.

There are many different types of image formats in use including: JPEG, bitmap, windows metafile, TIFF and others. In one embodiment, the automated counting system 1 may use the JPEG format and process to convert the image of the bundle. JPEG stands for Joint Photographic Experts Group, which is a standardization committee. It also refers to the compression algorithm. JPEG is a compression algorithm that has been provided to reduce the file size of, photographic-like true-color images as much as possible without affecting the quality of the image as experienced by the human senses. Because the size of the electronically converted image affects data transfer rates and storage capacity, it may be desirable to select a format that reduces the image size without taking away from the discernible details of the image. However, it is noted that any type of image format may be used as is appropriate for the embodiments.

The logic processing unit 3 may be a microcomputer 3′ as shown in FIG. 1. The microcomputer 3′ may include a microprocessor 19 supported by additional circuitry including memory and peripheral support circuitry. The microcomputer may further include static storage devices, e.g. a hard disk drive, for retaining data and other computer software programming code. In one embodiment, the microcomputer 3′ may store and/or sequence through programmed algorithms or software programs for analyzing the converted image data to determine the number of items in the bundle 14 as will be discussed below. The microcomputer 3′ may also process data related to the inventory of produced material, e.g. steel rods. In this manner, the microcomputer 3′ may store data related to the stocked quantities of materials, along with other information, in a database. By database, any grouping of data gathered for storage and retrieval as managed by a controlling program for accessing the data may be used. In an alternate embodiment, the inventory of the product may be stored on another computer or server whereby the microcomputer 3′ is networked or communicated to that server for the purpose of sending and retrieving inventory data. Still any convenient manner of storing and accessing the data of the inventory may be chosen.

The microcomputer 3′ may execute a computer algorithm or program for analyzing or interrogating the converted image. The computer algorithm or program may sequence through a series of program steps for counting the number of objects in the bundle 14. The computer algorithm may access a JPEG data file of the converted image from its stored location. In one embodiment, portions of the image are analyzed for the number of discernible configurations that represent the individual items within the bundle. Certain image portions may be discarded during the analysis as the algorithm deems appropriate as based upon initial parameters and other variables. The count of discrete discernible configurations may then be summed for output to the end user. In one embodiment, the computer algorithm may sequence through the process multiple times to verify the count, and derive a final answer based on an average. However, any manner of processing the image data to count the number of discernible configuration in the bundle 14 may be used as is appropriate for use with the embodiments of the subject invention.

With continued reference to FIG. 1, the computer algorithm performs digital configurations in the microcomputer 3′ and the display 11 may graphically display the image of the bundle 14 along with the computed count of the bundle 14. In this manner, a user of the system may see the item count as determined by the microcomputer 3′ and the corresponding algorithm. The display 11 may, if desired, further show additional information related to the bundle of material such as inventory data, purchase order data, and the like, which may be tracked by the system 1 and/or logic processing unit 3. The display 11 may show the type of material, e.g. rebar, being bundled, and other information such as the remaining inventory of material at this and possible other locations.

Once the microcomputer 3′ has completed the item count of the bundle, output from the computer algorithm may be communicated to the inventory system. In one embodiment, the item count may be sent to a server or computer managing the database of information comprising the inventory system. The item count may then be deducted from the overall quantity of items of that particular category. For example, steel bar having a 1 inch diameter and a characteristic length of 10 feet may comprise a particular category of inventoried material. The site where the material is bundled and counted may stock a specific unit count of the steel bar. Once the computer algorithm has completed processing the items, the microcomputer 3′ may automatically update the inventory to reflect the changes in quantity for this stocked item. In this manner, the system 1 may track the inventory of the items in real time as counted and bundled.

As shown in FIG. 1, the microcomputer 3′ and the display 11 may also be used to prompt the user of the system to enter in data related to the items being bundled. For example, the display 11 may prompt the user to enter information related to the material being banded and counted. The information may include purchase order or work order numbers, material type and/or length, as well as other information. The display 11 may further prompt the user to initiate the start of the cycle for executing the computer algorithm for automatically counting the items in the bundle. In this way, the microcomputer 3′ executes the computer algorithm when the user has completed the stacking and/or bundling process. Accordingly, the microcomputer 3′ may include a keyboard 7 or other input device for entering data into the microcomputer 3′.

As shown in FIG. 1, the automated counting system 1 may also include a printer 22 for printing labels 26 that can be used to tag the bundle 14. The labels 26, which may be tags, may include alpha-numeric characters indicating information related to the bundle and specifically the bundle item count as generated by the logic processing unit 3. Additionally, the labels 26 may list material type, material length, weight, and the like. Further information may be included such as order numbers and customer information. In fact, any desired information may be listed on the labels. The labels may also be printed with bar codes or other coded information for processing with scanners or other equipment. Subsequently, the labels 26 may be attached to the bundle 14 by fasteners, such as wire tags, adhesive labels or any other means for attaching the label 26 to the bundle 14. In this way, the bundle 14 may be clearly marked with the bundle item count for transportation to another destination.

An alternate embodiment contemplates that the materials bundled together may include two or more items 13 of different discernible configurations to be counted. For example, material having a first cross-sectional configuration may be bundled together with material having a second different cross-sectional configuration. By different it is meant that the discernible configurations may be different in shape and/or orientation sufficient for the system to recognize and count the different discernible configurations. For example, a first cross-sectional configuration of material may be generally circular, and a second cross-sectional configuration of material in the same bundle may be angles. However, different may also mean materials having the same general shape but different size, e.g. diameter. In this embodiment, the logic processing unit 3 or microcomputer 3′ may sequence through the algorithm discerning the different discernible configurations, as well as similar discernible configurations of the materials 13. The system 1 may then automatically count the number of items having the first discernible configuration and separately count the items having the second discernible configuration. Each of the first and second item counts may then be used to update the inventory of the respective items 13 in the bundle. In that the computer algorithm may discern between discernible configurations representing items to be counted and configurations representing other item or extraneous data, and a list of predetermined desired discernible configurations may be programmed into the microcomputer 3′ for use by the algorithm in automatically counting the bundled items. While the above mentioned description references first and second differently discernible configurations, it should be recognized that any number of materials having different shapes or other configurations may be recognized and counted by the system 1.

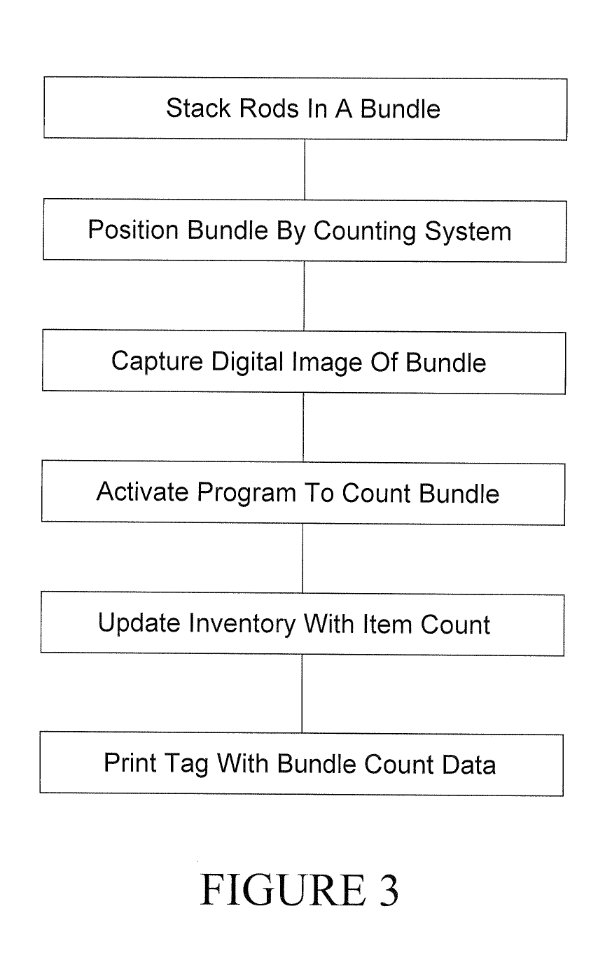

With reference especially to FIG. 3, a user may receive an order to bundle and band a specific amount of a particular material as dictated by weight. The user may then proceed to stack the particular material of a discernible configuration on a scale until the proper weight has been reached. The user may then proceed to band the group of material together and move the bundle to the automated counting system 1. The bundle may then be situated such that the end of the bundle is imaged by the imaging device 5. Upon activation by the operator, the automated counting system 1 may capture a digital image of the end view of the bundled material. The image may then be stored in memory in the microcomputer 3′ by comparison with a programmed computer algorithm to count the number of items in the bundle. The computer algorithm may cycle through a series of programmed steps analyzing the digital image for deriving the item count of the bundle. Subsequently, the inventory of the particular material may be automatically updated by the item count of the bundle. The automated counting system 1 may then prompt the user to print out a label for placement on the bundle identifying the number of items in this particular bundle.

The invention has been described herein with detailed reference to one or more embodiments. However, modifications and alterations will occur to those skilled in the art upon a reading and understanding of this specification. It is intended to include all such modifications and alternations in so far as they come within the scope of the claims or the equivalence thereof.

What is claimed:

1. A method of counting a plurality of items, comprising the steps of:
providing at least a first logic processor and a computer algorithm capable of recognizing a discernible configuration on a digital image and counting the number of similar discernible configurations on the image;
capturing an image of at least discernible configuration portions of a plurality of items having discernible cross-sectional configurations;
converting the digital image into an electronic data file that the computer algorithm is capable of recognizing; and
interrogating the electronic data file using the computer algorithm to automatically counting the number of discernible configurations on the image.

2. The method of counting a plurality of items as claimed in of claim 1 comprising the additional step of:
bundling the plurality of items before capturing the an image of at least discernible configuration portions of a plurality of items having discernible configurations.

3. The method of counting a plurality of items as claimed in of claim 2 comprising the additional step of:
stacking the plurality of items together to form the bundle until a predetermined weight has been achieved.

4. The method of counting a plurality of items as claimed in claim 1 further comprising the step of:
tracking the inventory of the plurality of items; and,
updating the inventory responsive to counting the number of the plurality of items.

5. The method of counting a plurality of items as claimed in claim 1 further comprising the step of:
tagging the plurality of items with an item count generated from the computer algorithm.

6. The method of counting a plurality of items as claimed in claim 1 where:
the computer algorithm capable of distinguishing between a first discernible configuration and at least a second substantially different discernible configuration on a digital image; and
counting the numbers of items with similar discernible configurations of both the first and the second discernible configurations on the image.

7. The method of counting a plurality of items as claimed in claim 6 further comprising the step of:
tracking the inventory of the plurality of items; and,
updating the inventory responsive to the counts of the items of both the first and second discernible configurations.

8. A system for counting a plurality of items grouped together in a bundle, comprising:
a camera for converting images into a electronic data file;
a computer operatively communicated to the camera and being adapted to interrogate the data file through a program to count the number of said items imaged in the data file; and
an information database operatively communicated to the computer capable of storing in inventory data the count of said items and updating the information data base responsive the count of said items.

9. A system for counting a plurality of items grouped together in a bundle, comprising:
an image capturing device for digitally converting images to an electronic data file;
at least a first logic processor operatively communicated to receive the data file from the image capturing device, and having using a computer algorithm capable of analyzing the data file to identify to output the number of plurality of items grouped together in a bundle;
memory operatively communicated to the logic processor for use in storing data capable of storing the number identified of the plurality of items grouped in a bundle; and
a printer operatively communicated to said first logic processor capable of printing on bundle tags the number identified of the plurality of items grouped in a bundle.

10. The system for counting a plurality of items grouped together in a bundle as claimed in claim 9 further comprising:
a scale capable of weighing the plurality of items grouped in the bundle.

11. The system for counting a plurality of items grouped together in a bundle as claimed in claim 9 further comprising:
a second logic processor operatively communicated to the first logic processor, and having memory for use in storing inventory data, where the inventory data may be automatically updated responsive the output from the computer algorithm identifying the number of the plurality of items grouped together in a bundle.

12. The system for counting a plurality of items grouped together in a bundle as claimed in claim 9 where:
the electronic image capturing device is a digital camera.

13. The system for counting a plurality of items grouped together in a bundle as claimed in claim 9 where:
the first logic processor is a microcomputer comprising a microprocessor and memory for storing electronic data.
